(19) United States
(12) Patent Application Publication
(10) Pub. No.: US 2023/0054696 A1
(43) Pub. Date: Feb. 23, 2023

(54) USER-LEVEL SERVICES FOR MULTITENANT ISOLATION

(71) Applicants: Giorgos KAPPES, Ioannina (GR); Stergios V. ANASTASIADIS, Ioannina (GR)

(72) Inventors: Giorgos KAPPES, Ioannina (GR); Stergios V. ANASTASIADIS, Ioannina (GR)

(21) Appl. No.: 17/884,922

(22) Filed: Aug. 10, 2022

Related U.S. Application Data
(60) Provisional application No. 63/231,426, filed on Aug. 10, 2021.

(51) Int. Cl. G06F 9/50; G06F 9/54; G06F 16/176

(52) U.S. Cl. CPC G06F 9/5011; G06F 9/547; G06F 16/176; G06F 9/544; G06F 9/5077; G06F 9/545; G06F 2209/5011

(57) ABSTRACT

A shared computing system for serving a plurality of tenants using container pools. Each container pool has a filesystem service configured to service one or more applications within the container pool. A shared memory is used to facilitate interprocess communication between the application and the filesystem service, both of which along with the interprocess communication itself are run at user level.

### CROSS-REFERENCE TO RELATED APPLICATIONS

This application claims priority to and the benefit of U.S. Provisional Application No. 63/231,426, filed on Aug. 10, 2021. The disclosure of the above application is incorporated herein by reference.

### FIELD

The present disclosure relates to shared network resource systems, and more generally to a method and system of providing access to user-level services in a shared resource environment.

### BACKGROUND

The statements in this section merely provide background information related to the present disclosure and may not constitute prior art.

System memory comprises two distinct regions—a kernel space and a user space. The kernel space is where the kernel (the core of the operating system) executes and provides its services. The kernel space has unrestricted access to the underlying hardware and is reserved for the highest trusted functions within the system. As such, any instability within the kernel space can result in complete system failure. On the other hand, the user space has limited access to system resources. The user space is an environment in which user processes run. A user process may access system resources from the kernel space by issuing system calls.

In managing system resources, the kernel generally relies on control groups (cgroups) and namespaces. Cgroups are a kernel mechanism for limiting and measuring the total resources used by a group of processes running on the system. Namespaces, on the other hand, are a kernel mechanism for limiting the visibility that a group of process has of the rest of the system. Cgroups and namespaces form the foundation of containerization technology—a form of operating system virtualization through which applications are run in isolated environments called containers, all using the same shared operating system.

Containers are an executable unit of software that bundles an application's code together with the related configuration files and libraries, and with the dependencies required for the application to run. Containers offer several benefits over traditional or hardware virtual machine technologies. In one form, because containers share the host operating system, each container does not need to boot an operating system or load libraries. As such, containers are light-weight and have low overhead software virtualization alternative to traditional virtual machines. Yet, because they share the same operating system and system resources, performance isolation of the container-based system is not guaranteed.

For instance, because there is no specific guarantee for isolation of the kernel execution between containers on the host, one rogue container can consume all Computer Processor Unit (CPU) cycles, thereby starving other containers executing on the host. Similarly, when a data-intensive container competes with a noisy neighbour, the kernel I/O services can experience performance variability and slowdown. Dynamic resource allocation, kernel structure replication, and hardware-level virtualization have been explored as viable solutions, yet, deploying any of these increases the overhead significantly.

Apart from the above-noted challenges, the kernel introduces limitations that make the execution of data-intensive applications problematic.

First, kernel services are known to consume resources (memory space, CPU time, etc.) which are inaccurately accounted to the processes, raising fairness concerns.

Second, when completing certain I/O activities for a tenant, kernel services consume resources that often exceed resources reserved for that tenant (e.g., cpu time for page flushing).

Third, there are consumable resources (e.g., software locks) that remain unaccounted for due to their allocation complexity (e.g., arbitration of synchronization instructions), whose mitigation requires complex restructuring of the application or system code.

Fourth, the kernel involvement incurs implicit hardware costs (e.g., mode switch, cache pollution, TLB flushes) that penalize unfairly the co-located tenants regardless of the relative intensity of their I/O activity.

Fifth, the monolithic nature of the kernel complicated the customized configuration of the system parameters (e.g., page flushing) desired by each tenant.

Sixth, implementing new filesystems to meet container storage needs generally follows traditional kernel software development, making it time-consuming. Nowadays, many developers have begun to develop filesystems in user space rather than in-kernel implementations due to the ease of development/maintenance of code in user space. Nevertheless, frameworks (e.g., FUSE) that allow non-privileged users to develop filesystems in user space lead to increased overhead cost because of frequent user-kernel switching and data copying.

Seventh, the storage I/O of co-located tenants is handled by the shared kernel, raising contention issues. Similarly, because the co-located tenants share the same storage I/O path, co-located tenants are vulnerable to attacks and/or bugs.

Eighth, although the kernel provides configurable limits of the hardware resources, it does not guarantee the fair allocation of high-level system services between multiple containers. For instance, multiple containers accessing the same file may share a single page cache entry for that file. While cgroups can be used to pin process groups to specific cores and assign resident pages to processes that first requested them, when dirty pages exceed a predetermined threshold, the kernel flusher run on arbitrary system cores rather than those reserved by the process. As such, existing files may be prematurely deleted from the page cache to accommodate newer files.

A cloud-based ecosystem offers several options to support the container storage needs. These include an image repository, a root filesystem and application data, respectively known as registry storage, storage driver and volume storage in Docker. A host copies the container images to local storage from a centralized repository, or accesses them directly from a network storage system (SAN or NAS). The root filesystem and the application data are also kept in local storage, or accessed from network storage. The storage is ephemeral if it is deleted at container termination, or persistent if it exists independently of the container lifetime. The ephemeral storage lives at the local filesystem of the host, and the persistent storage is served by a network storage system.

Although improved cross-tenant isolation is traditionally achieved through hardware-level virtualization or partitioning, cloud providers increasingly manage their resources through containers. The virtualization based on hardware or the operating system introduces I/O contention and performance variability in multitenant hosts. The I/O-intensive applications running on manycore machines experience scalability bottlenecks from filesystem consistency, locking and locality

### SUMMARY

This section provides a general summary of the disclosure and is not a comprehensive disclosure of its full scope or all of its features.

In one aspect of the present disclosure, a shared computing system for serving a plurality of tenants comprises: a container pool for each of the plurality of tenants, each container pool comprising: a container including an application; a filesystem service configured to service the application; and a shared memory configured to facilitate interprocess communication between the application and the filesystem service; wherein the application, the interprocess communication and filesystem service are run at a user level.

In some cases, the container pool is used for dynamically provisioning one or more of a client and server of a storage system.

In some cases, the container pool is configured to provide a libservice as a standalone functionality derived from a library that runs an I/O function at the user level to provide an I/O service through composition with one or more other libservices.

In some cases, the application accesses the filesystem service through an interface supporting standard system calls.

In some cases, the container further comprises a plurality of applications, and wherein the container pool further comprises a plurality of filesystem services.

In some cases, the container pool is provided by a plurality of hosts, wherein a respective pool manager is provided for each host of the plurality of hosts to manage the container pool of each host to allocate resources for each host.

In some cases, the interprocess communication between the application and the filesystem service is configured to run at a kernel level to facilitate a dual interface implementation.

In some cases, the shared memory comprises a mount table configured to facilitate instantiating and accessing a filesystem instance of the filesystem service for a corresponding application.

In some cases, the mount table stores a mount path identifying the address of the filesystem service for access by the application.

In some cases, a filesystem table in the filesystem service specifies the filesystem instance that serves the mount path.

In some cases, the shared memory further comprises a queue to facilitate transferring requests from the application to the filesystem service.

In some cases, the container pool comprises one or more request buffers per application thread in the shared memory to transfer data and notifications between the application and the filesystem service.

In some cases, the queue comprises a fixed-size array data structure.

In some cases, the queue comprises two stages for each of enqueue and dequeue operations, wherein in a first stage an operation is assigned sequentially to one slot of a plurality of slots in the queue; and in a second stage the operation is completed, wherein the second stage runs in parallel across the plurality of slots and without order restrictions relative to the one slot or other slots of the plurality of slots (other than removing an item after it is inserted).

In some cases, the queue is configured to operate in a blocking mode.

In some cases, the queue is configured to operate in a non-blocking mode.

In some cases, the computing system further comprises a two-stage pipeline for memory transfer to a destination memory address, wherein: in a first stage cache lines are prefetched into a non-temporal cache structure; and in a second stage the prefetched cache lines are transferred to the destination memory address.

In some cases, a predetermined number of prefetches are performed prior to the prefetched cache lines being transferred to the destination memory address.

In some cases, the computer system further comprises a memory copy with cross-platform optimization through offline exhaustive search to identify the best performance across different parameters including the data transfer size for a particular computing platform.

In some cases, the computing system further comprises a memory copy with cross-platform optimization through search occurring during normal service to identify improved performance across different parameters.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1a is a diagram showing throughput per pool of RocksDB over Ceph storage in prior art systems;

FIG. 1b is a diagram showing latency per pool of RocksDB over Ceph storage in prior art systems;

FIG. 2 is a block diagram of components of a storage system in accordance with the teachings of the present disclosure;

FIG. 3 is a block diagram showing communication routing within the container pool of FIG. 2, accordance with the teachings of the present disclosure;

FIG. 4 is a block diagram of the container pool of FIG. 2, accordance with the teachings of the present disclosure;

FIG. 5 is a flowchart illustrating the operations performed by the processor in updating a mount table, accordance with the teachings of the present disclosure;

FIG. 6 is a block diagram of an interprocess communication (IPC) subsystem of Polytropon, in accordance with the teachings of the present disclosure;

FIG. 7 is a flowchart illustrating how I/O requests are processed by an IPC system in accordance with the teachings of the present disclosure;

FIG. 8a is a diagram showing a method of data transfer between the front driver and the back driver, in one form a cross-memory attach (CMA) method, in accordance with the teachings of the present disclosure;

FIG. 8b is a diagram showing a method of data transfer between the front driver and the back driver, in one form a shared-memory copy (SMC), in accordance with the teachings of the present disclosure;

FIG. 8c is a diagram showing a method of data transfer between the front driver and the back driver, in one form a shared-memory optimized (SMO), in accordance with the teachings of the present disclosure;

FIG. 9a is a diagram showing a Relaxed Concurrent Queue Blocking (RCQB) that is partly full and partly empty, in accordance with the teachings of the present disclosure;

FIG. 9b is a diagram showing a Relaxed Concurrent Queue Blocking (RCQB) that is full, in accordance with the teachings of the present disclosure;

FIG. 9c is a diagram showing a Relaxed Concurrent Queue Blocking (RCQB) that is empty, in accordance with the teachings of the present disclosure;

FIG. 10, is a block diagram of a host in communication with a storage backend, in accordance with the teachings of the subject disclosure;

FIG. 11a is a plot showing put latency per pool of RocksDB storage engine over Polytropon, FUSE and kernel-based clients, in accordance with the teachings of the present disclosure;

FIG. 11b is a plot showing get latency per pool of RocksDB storage engine over Polytropon, FUSE and kernel-based clients, in accordance with the teachings of the present disclosure;

FIG. 11c is a plot showing average put/get throughput per pool of RocksDB storage engine over Polytropon, FUSE and kernel-based clients, in accordance with the teachings of the present disclosure;

FIG. 11d is a plot showing average and total lock wait and hold times of RocksDB storage engine over Polytropon, FUSE and kernel-based clients for 32 container pools, in accordance with the teachings of the present disclosure;

FIG. 12a is a plot showing timespan to start and run containers with Gapbs for Polytropon, FUSE and kernel-based clients, in accordance with the teachings of the present disclosure;

FIG. 12b is a plot showing timespan to start and run containers with source code diff for Polytropon, FUSE and kernel-based clients, in accordance with the teachings of the present disclosure;

FIG. 12c is a plot showing timespan to start and run containers with Fileappend for Polytropon, FUSE and kernel-based clients, in accordance with the teachings of the present disclosure;

FIG. 13 is a plot showing application performance of running Filebench Singlestreamread (Seqread)/Ceph across RCQB, Broker Queue (BQ), and Two-Lock Queue (TLQ), in accordance with the teachings of the present disclosure;

FIG. 14a is a plot showing average enqueue latency of synchronous tasks over RCQB, LCRQ, WFQ and BQ, in accordance with the teachings of the present disclosure;

FIG. 14b is a plot showing throughout of synchronous tasks over RCQB, LCRQ, WFQ and BQ, in accordance with the teachings of the present disclosure;

FIG. 15 is a plot showing throughout of data transfer with Shared Memory Optimized (SMO), Cross-Memory Attach (CMA) and Shared-Memory Copy (SMC), in accordance with the teachings of the present disclosure;

FIG. 16 is a plot showing cost of running Polytropon and FUSE for different I/O size, in accordance with the teachings of the present disclosure;

FIG. 17 is a plot showing performance of the kernel, FUSE and Libservices based client with and without Stress, in accordance with the teachings of the present disclosure;

FIG. 18 is a plot showing performance of the Ceph/kernel, Ceph/FUSE and Libservices, in accordance with the teachings of the present disclosure;

FIG. 19a is a plot showing experimental performance results of a enqueue latency for a Relaxed Concurrent Queue Single (RCQS) algorithm, in accordance with the teachings of the present disclosure;

FIG. 19b is a plot showing experimental performance results of a dequeue latency for a RCQS algorithm, in accordance with the teachings of the present disclosure;

FIG. 19c is a plot showing experimental performance results for a RCQS algorithm in one form, in accordance with the teachings of the present disclosure;

FIG. 19d is a plot showing experimental performance results for a RCQS algorithm in one form, in accordance with the teachings of the present disclosure;

FIG. 20a is a plot showing data throughput of cross-platform optimization in one form, in accordance with the teachings of the present disclosure; and

FIG. 20b is a plot showing data throughput of cross-platform optimization in one form, in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

As used herein, an element or feature introduced in the singular and preceded by the word “a” or “an” should be understood as not necessarily excluding the plural of the elements or features. Further, references to “one example” or “one variation” are not intended to be interpreted as excluding the existence of additional examples or variations that also incorporate the described elements or features. Reference herein to “example” means that one or more feature, structure, element, component, characteristic and/or operational step described in connection with the example is included in at least one variation and/or implementation of the subject matter according to the subject disclosure. Thus, the phrases “an example,” “another example,” and similar language throughout the subject disclosure may, but do not necessarily, refer to the same example. Further, the subject matter characterizing any one example may, but does not necessarily, include the subject matter characterizing any other example.

Unless explicitly stated to the contrary, examples or variations “comprising” or “having” or “including” an element or feature or a plurality of elements or features having a particular property may include additional elements or features not having that property. Also, it will be appreciated that the terms “comprises”, “has”, “includes” means “including but not limited to” and the terms “comprising”, “having” and “including” have equivalent meanings.

Reference herein to “configured” denotes an actual state of configuration that fundamentally ties the element or feature to the physical characteristics of the element or feature preceding the phrase “configured to.”

In the following, systems and methods for improving I/O performance isolation of containers in a multi-tenant system are described and illustrated. In general, a multi-tenant system is an architecture that allows tenants (customers) to share computing resources in a cloud environment. The multi-tenant system relies on containers for running applications of the different tenants. The containers may be managed by an orchestration system such as Kubernetes that automates the resource allocation and application scheduling over numerous machines.

To demonstrate some of the limitations of existing containerized technology, vis a vis, performance isolation between containers, multiple data-intensive container pools were run on a host to determine the throughput and latency as the number of container pools increases. Each container pool contained one or more containers and reserved 2 cores and 8 GB of RAM of the host to run one container, with a RocksDB storage engine serving a 50-50 mix of put/get operations. Each container pool had one of a FUSE-based or kernel-based Ceph client for mounting a root filesystem of the container from a Ceph storage cluster. The root filesystem of the container accommodated both the container image and the RocksDB data files.

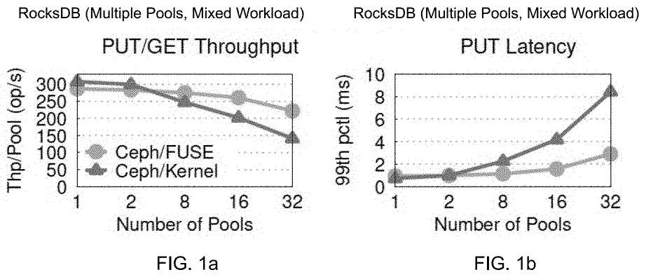

Referring to FIG. 1, the network's throughput per pool and tail latency are shown as a function of the number of pools. As seen in the figure, as the number of pools increased from 1 to 32, the throughput per pool (higher is better) decreases for both the FUSE-based and the kernel-based Ceph client. In one form, the throughput per pool for the former decreased by 23% while the latter decreased by 54%. Similarly, the latency (lower is better) increased as the number of pool increased.

In one scenario, both the throughput per pool and latency per pool should remain constant as the number of pools is increased up to the host capacity. The fact that this is not the case for both the FUSE-based and kernel-based Ceph clients suggest that the kernel path limits the I/O performance isolation of the pools. In one form, the results suggest that the pools compete in the kernel on shared data structures (e.g., filesystem metadata), which causes excessive lock time. Second, the I/O handling is hampered by kernel background activity (e.g., dirty page flushing) on resources (e.g., cores) of the pools that are unrelated to the activity.

A storage system consists of clients and servers, dynamically provisioned (for example, root filesystems and application filesystems) or permanently operated (for example, an image repository) by the provider. The clients and servers serve the image repository, the root filesystems that boot the containers, and the application filesystems with the application data. The image repository stores the container images of the root or application filesystem servers, and the applications. The root filesystem servers of a tenant are launched by having their images copied from the repository. The applications and filesystem servers are launched through clients accessing their images from the root filesystem servers. Application data is accessed through clients from the application filesystem servers. An application runs with the following steps: (i) Identify the hosts of the root or application filesystem servers, and the applications (ii) Use one or more container engines to transfer and launch the images of the root filesystem servers. (iii) Store at the root filesystem servers the images of the application filesystem servers and the applications. (iv) Launch the application filesystems and the applications over the root filesystem clients.

A network storage client accesses binaries or data in the form of blocks, files, or objects. The proposed solution focuses on block-based or file-based clients, which can efficiently serve the container storage needs. A block-based client serves a block volume on which a local filesystem is run. Treating entire volumes as regular files facilitates common management operations, such as migration, cloning and snapshots, at the backend storage. Despite this convenience, the block volume is only accessible by a single host and incurs the overhead of mounting the volume and running on it a local filesystem. In contrast, a file-based client natively accesses the files from a distributed filesystem. Multiple hosts directly share files through distinct clients, but with the potential server inconvenience of managing application files rather than volumes. Since both file-based and block-based clients are widely used in container storage, both are supported.

The root filesystems of a tenant should be isolated and managed efficiently. The efficiency refers to the storage space of the backend servers, the memory space of the container hosts, and the memory or network bandwidth. The block-based storage accommodates a root filesystem over a separate block volume possibly derived from an image template. The backend storage supports volume snapshots to efficiently store the same blocks of different volumes only once. Under the volume clients, a shared cache transfers the common volume blocks of the tenant over the network only once. A separate cache in the root filesystem lets the container reuse the recently accessed blocks without additional traffic to the shared client cache. Alternatively, the file-based storage accommodates a root filesystem over a shared network filesystem accessed by the client of the tenant. A separate union filesystem over each root filesystem deduplicates the files of different container clones to store them only once at the backend. A transfer of the common files of the root filesystems to the host is only made once with a shared cache inside the distributed filesystem client. The above caching and deduplication procedures can be similarly applied to application filesystems.

The system described below allows each tenant to run both the applications and system services at user level over reserved hardware resources. A distributed storage system provides elasticity over multiple data and metadata servers. Elasticity refers to the dynamic adjustment of the tenant resource allocation according to configured reservations and utilization measurements. The application hosts provide per tenant shared storage and efficient caching. The storage servers support efficient copy-on-write deduplication (e.g., for image cloning). The resource allocations adapt dynamically to the tenant requirements and the current utilization.

The framework described herein achieves multitenant I/O isolation at reasonable engineering effort. It consists of the user-level services derived from existing user-level codebases. Isolation refers to the resource utilization of the tenants limited by their configured reservations. The framework provides direct access to local storage devices or filesystems, and client access to remote storage devices or distributed filesystems. An application or server process accesses the service framework over a user-level communication component through a linked library.

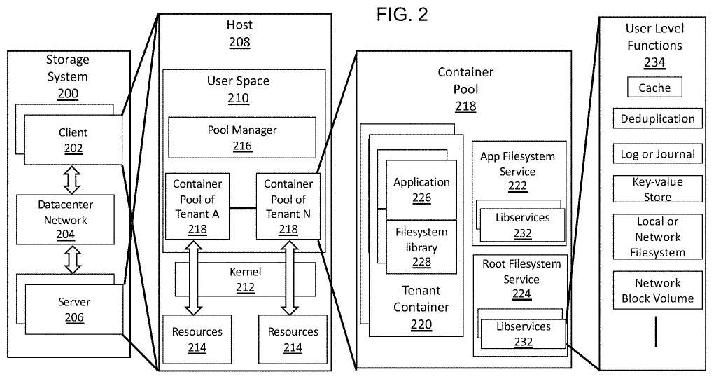

Referring to FIG. 2, a block diagram of components of a storage system in accordance with the subject disclosure is shown. As can be seen, the storage system 200 comprises a client 202, a server 206, and a data network 204. The client 202 and the server 206 each comprise one or more hosts 208. Each host 208 comprises a user space 210, a kernel 212, and one or more resources 214. The user space 210 comprises a pool manager 216 and one or more container pools 218, each container pool 218 associated with a corresponding tenant. Each container pool 218 comprises one or more tenant containers 220, one or more application filesystem services 222 and root filesystem services 224. Each container 220 comprises one or more applications (or application processes) 226 and one or more filesystem library 228, each one of applications 226 associated with a respective filesystem library 228. The application filesystem service 222 and the root filesystem services 224 each comprise a plurality of libservices 232. Libservices 232 comprise a plurality of user-level functions 234, such as caches, deduplication, log or journal, key-value store, local or network filesystem, network block volume and the like.

The client 202 is communicatively coupled to the server 206 via the data network 204. In this variation, the data network 204 is the datacenter local network. Although not shown in the figure, the host 208 further comprises a processor, storage device, memory and one or more network interfaces. The storage device of the host may include a plurality of storage devices such as hard disk drives, solid state drives, persistent memory or the like.

The user space 210 is the environment where user processes function and execute. The kernel 212 lives in a kernel space (not shown). The kernel 212 manages the system's hardware as well as perform resource and device management in the multi-tenant environment. Resource management consists of multiple tasks including, reservation, allocation, provisioning, orchestration, and scheduling of system resources e.g., central processing units (CPUs), physical memory, disk, network bandwidth, etc. Device management provides protected operation of the local devices among the processes of the co-located tenants. Example of such operations include allocating device(s) to processes, initiating operations by device(s), and reclaiming the device(s) on task completion. In some variations, resource management and device management are performed by cgroups and device drivers; however, other kernel mechanisms can be configured to perform this functionality.

The pool manager 216 is a standalone process that manages the container pools 218 of a host 208 and is responsible for allocating resources 214 elastically according to recorded reservations and utilizations. The container pool 218 is a group of containers 220 that a tenant runs on the host 208. The container pool 218 of a tenant mounts the filesystems and specifies the namespaces and resource usage limits of the containers 220 within the container pool 218. Each container 220 in the container pool 218 is executed by the kernel 212 with the reserved resources of the tenant. Each application 226 running in a container 220 obtains access to the filesystem services 222 and 224 through a pre-loaded or linked filesystem library 228 and communicates with the filesystem services 222 and 224 over shared memory.

The filesystem services 222 and 224 are a collection of user-level I/O services implementing a local or network filesystem. In this variation, the filesystem services are built from libservices. Libservice 232 is a user-level layer implementing a particular filesystem functionality and is configured to dynamically provision the application filesystems, root filesystems, and image repositories per tenant. In one form, libservice 232 is an abstraction of a user-level filesystem implemented as a library having an interface that is POSIX-compliant without dependencies from global variables. Libservice 232 is derived from existing libraries that runs a storage function at user level.

Libservice 232 is responsible for providing user-level functions such as caching, deduplication, logging or journaling, key-value store, local filesystem, network access to a file or block storage system etc. The libservice is an abstraction of a user-level filesystem implemented as a library with a POSIX-like interface. The libservices implement a range of functionalities, such as (i) a local filesystem over a direct-attached device or network block volume, (ii) a client of network attached storage from a distributed filesystem, (iii) a union filesystem offering file-level deduplication, or (iv) a cache based on a local storage device or memory. A libservice may also support caching of the offered functionality with customized settings for a tenant application.

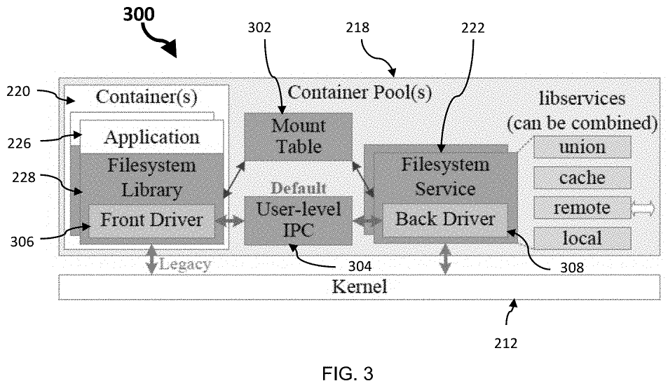

A toolkit, referred to as the Polytropon toolkit, provides a collection of user-level components configurable to build several types of filesystems. The toolkit provides an application library to invoke the standard I/O calls, a user-level path to isolate the tenant I/O traffic to private host resources, and user-level filesystem services distinct per tenant. The main Polytropon toolkit components are the filesystem service, the filesystem library, a mount table, and interprocess communication. Referring to FIG. 3, a block diagram showing the main components of the Polytropon toolkit is shown and generally identified by reference numeral 300. In this variation, the container pool 218 comprises one or more containers 220, the mount table 302, a user-level interprocess communication (IPC) namespace 304, and one or more filesystem services 222. Each container 220 comprises one or more applications 226 having an associated filesystem library 228. The filesystem library 228 includes a front driver 306. Each filesystem service 222 comprises a back driver 308 and a stack of libservices. The topmost libservice in the stack is unique to the application filesystem service 222 and mimics a union filesystem, while the other libservices in the stack are sharable and mimic the clients of a distributed filesystem.

In this variation, each container 220 is configured to run at least one application 226. The application 226 accesses the filesystem service 222 via the filesystem library 228, which is preloaded to the container. The filesystem library 228 communicates with the filesystem service 222 via the mount table 302 and the user-level IPC namespace 304.

The filesystem library 228 includes a front driver 306 configured to communicate I/O requests from the application 226 to the back driver 308 of the filesystem service 222. The front driver 306 sends user level I/O requests to the back driver 308 via the mount table 302 and the IPC subsystem 304, of which each request specifies a filesystem instance that will serve the request. When the back driver 308 receives a request, it parses the request to determine the filesystem instance required to fulfil the request. The back driver 308 then accesses the filesystem instance from within the filesystem service 222.

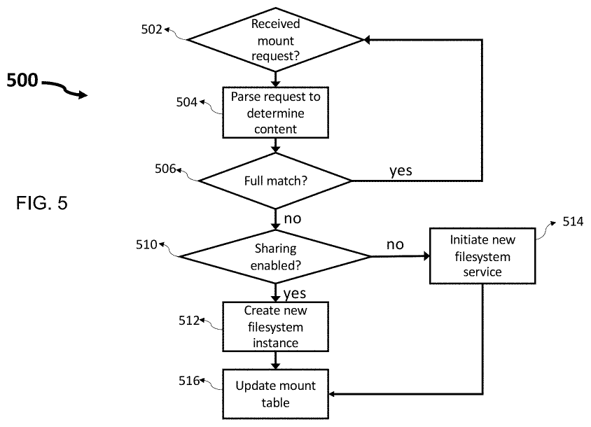

To reduce mode switches and processor cache stalls, a filesystem service is invoked by an application (or server process) through an IPC subsystem at the user-level. As will be described with reference to FIG. 5, the IPC subsystem is implemented with a circular queue over shared memory inside the IPC namespace 304 of the container pool 218. The I/O requests of the application are placed in the circular queue to be extracted by the filesystem service. At the filesystem service, an I/O request passes through the topmost libservices of the filesystem service before reaching the local storage device or the network client if necessary. A response to the I/O request is sent back without queue involvement through a shared memory buffer prepared by the sender and referenced by the request.

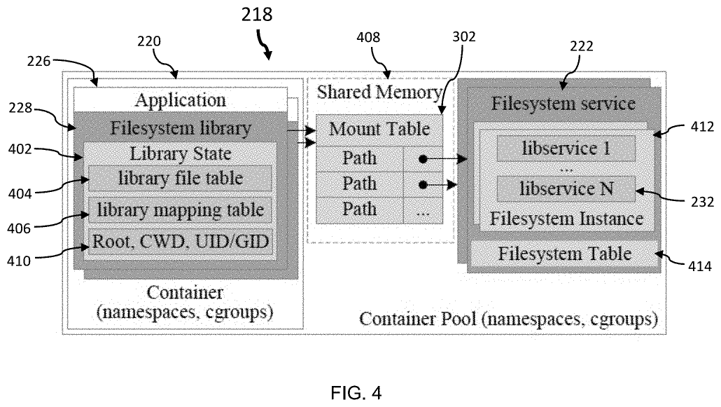

Referring to FIG. 4, structure of the filesystem library, the filesystem service, and the mount table illustrated in FIG. 2 is shown in greater detail. As illustrated, the container pool 218 comprises the container 220, a shared memory 408, and one or more of the filesystem services 222. Each filesystem library 228 in the container 220 includes a library state 402. The library state 402 includes a library file table 404, a library mapping table 406, one or more directories and identifiers 410 (e.g., root directory, current working directory (CWD), user identifier (UID), and group identifier (GID)). The shared memory 408 includes a mount table 302 storing one or more paths. Each filesystem service 222 of the container pool 218 comprises one or more filesystem instances 412 and a filesystem table 414. Each filesystem instance 412 of the filesystem service 222 comprises one or more of the libservices 232.

A tenant requires the configuration flexibility to access a number of different filesystem types on a shared host. For isolation and efficiency, the filesystems of a tenant should run at user level and share functionalities in configurable ways. For example, a container typically mounts a private root filesystem sharing read-only branches with other containers, and optionally mounts several application filesystems that can be fully shared in read-write mode. Furthermore, cross-tenant filesystem sharing can be supported by establishing a common container pool among the collaborating tenants.

The filesystem service 222 is a user-level process that handles the container storage I/O in the container pool 218. Each filesystem instance 412 is a mountable user-level filesystem implemented as a collection of one or more stackable libservices 232. Although the topmost libservice is private (e.g., a union filesystem), the libservices underneath are shareable (e.g., client of distributed filesystem). Each filesystem instance 412 is specified by the libservice objects 232, and a mount path that is unique in the container pool's mount namespace. When mounting a new filesystem, the filesystem service 222 creates a new filesystem instance 412 and inserts a new entry in the filesystem table indexed by a unique identifier.

The back driver 308 of the filesystem service 222 receives user level I/O requests from the applications 226. The request specifies the filesystem instance 412 that will serve it from the libservices 232, starting from the topmost libservice and moving to the lower libservices as desired. For example, when the topmost libservice returns a file descriptor (e.g., serving an open call), the back driver 308 instantiates a service open file in memory. The service open file structure stores the open file state, which can be shared across multiple processes. The open file state includes the filesystem instance identifier, the file descriptors of the libservices, the file path (e.g., openat), the reference count, and the call flags. Part of the state (e.g., file offset) is maintained directly in the libservices. The service file descriptor is the memory address of the service open file returned to the front driver 306 as a file handle. A close request decrements the reference count and closes the file when it reaches zero. A similar approach for other types of descriptors, such as the directory streams, is also followed.

The mount table 302 is a hash table that translates a mount path to the filesystem service 222. The actual filesystem instance 412 that serves the mount path is specified by the filesystem table 414 of the filesystem service 222. The mount table is located in a shared memory 408 that is accessible by the applications 226 and the filesystem services 222 of the pool. A mount request to mount a new filesystem includes the mount path, the filesystem type, and a list of options.

Referring to FIG. 5, a flowchart illustrating the operations performed by the processor in updating the mount table is shown and is generally identified by reference numeral 500. At step 502 the processor monitors the shared memory to check whether mount request has been received. At step 504, the processor parses the request to determine its content. At step 506, the processor determines from the content of the request whether the mount path specified in the request fully matches one stored in the mount table. A full match signifies that the filesystem instance has already been mounted. In determining that the request fully matches one that already exists, the operation completes immediately because the specified filesystem instance is already mounted.

If the match is a partial match, then at step 510, the processor checks whether a sharing option is enabled within the mount request. The sharing option indicates that the filesystem instance requested should share libservices with an existing filesystem instance. If the sharing option is enabled, at step 512 a new filesystem instance 412 is created using the shared libservices 232 specified in the list of option in the mount request. A new entry is added to the mount table 302 for the mount path to the new filesystem instance 412.

Otherwise, at step 514 a new filesystem service 222 is initiated with a new filesystem instance 412. At step 516, the processor updates the mount table 302 with a new entry for the corresponding mount path of the new filesystem instance 412.

The filesystem library 228 supports a significant number of library functions, including file I/O (e.g., mount, read, opendir, fopen), process management (e.g., fork), asynchronous I/O (e.g., aio_read), network I/O (e.g., send), and memory mappings (e.g., mmap). A design challenge in providing such functionality was the support of POSIX-like compatibility in the I/O system calls. In order to address this challenge, the most convenient locations of the I/O path to store the file I/O state needed to be determined. Storing the state in the filesystem library 228 favors the isolation but complicates multiprocess sharing. Accordingly, the file I/O state is split and a private part is stored in the filesystem library 228 and a shared part is stored the filesystem service 222. This configuration provides the correct semantics to processes with shared state (e.g., parent and child). The following examples describe the steps to maintain the correct interface across different categories of system calls.

open: The private part of the file I/O state of a process is stored in the library state 402. The library state 402 includes open file descriptors, user identifiers, root and current directory of the file I/O state. For each open file, the library file table 404 maintains the library open file structure including the service file descriptor and the mount table entry. The index of the open file is the library file descriptor returned to the application as a file descriptor of a successful open call. The opendir call is similarly handled by storing the directory stream pointer as service file descriptor and returning the library file descriptor casted to a directory stream pointer.

sockets: An I/O system call (e.g., read) accepts a socket descriptor as file descriptor argument. This is achieved by configuring the filesystem library 228 to override all standard I/O functions that manipulate network sockets. The filesystem library 228 stores the socket descriptor and returns (to the application) the library file descriptor as socket descriptor.

fork: The system calls are modified to correctly handle the filesystem state during process management such as fork, clone, and pthread_create. At a fork, the filesystem service 222 increments the reference count of the open files in the parent. The filesystem library 228 invokes the native fork and replicates the library state from the parent to the child process.

exec: the exec function overwrites the original library state when loading a different executable in the address space. During an exec call, the filesystem library 228 first preserves the library state with a copy that it creates in shared memory. Subsequently, the native exec loads the new executable and invokes the filesystem library 228 constructor to recover the library state from the copy in shared memory 408.

mmap: The mmap call requires the kernel to modify the page table and dynamically read the file contents of the mapped memory addresses. The filesystem library 228 partially emulates this interface by mapping the specified address area to memory and synchronously reading the file contents. The library mapping table is a hash table that pairs the memory address with the address area length, the file offset, the service file descriptor, the mount table entry, and the call flags. The library mmap call creates an anonymous mapping through the native mmap call. The requested file portion is transferred to the mapping area with the library pread call, the file reference count is incremented, and a new entry is created in the library mapping table. The library msync and munmap calls are analogously supported, with the library pwrite transferring data to the backing file.

libc: the filesystem library supports libc API (e.g., fopen) by using the fopencookie mechanism to manage the custom I/O streams. The library open function is used to open a file and returns the library file descriptor. The filesystem library 228 read, write, close and seek functions are provided as hook functions to fopencookie.

aio: POSIX asynchronous I/O interface (AIO) is supported based on code from the musI library.

The system may also be configured to provide a dual interface. That is, the I/O requests to the filesystem services are routed through I/O paths at user level by default. However, the I/O path may cross the kernel when backward compatibility with legacy software is desired. With regards to the dual interface, an unmodified application can be linked to the filesystem library with preloading. At process load, a dynamic linker invokes a library constructor to instantiate a new filesystem library and override common library functions such as open, read, and fork. In general, a statically-linked application normally requires modification of the application source code in order to use the Polytropon toolkit. As a backward-compatible alternative, an optional legacy path is provided that first directs an I/O call to the kernel VFS API and then to the filesystem service through the FUSE API. This approach skips dynamic linking or recompilation to automatically support all the system calls involving I/O (e.g., read, exec, mmap) at the cost of sacrificing the benefits of the default user-level path.

Referring to FIG. 6, a block diagram of an IPC subsystem is shown and is generally identified by reference numeral 600. The IPC subsystem comprises the front driver 306, the shared memory 408, and the back driver 308. The front driver 306 comprises an application thread 602 and an outstanding request table per application thread 604. The shared memory 408 comprises one or more request queues 610, a request buffer 614 per application thread and a completion notification 612 per request buffer. The back driver 308 comprises a filesystem service thread 606 and filesystem buffers 608.

I/O requests originating from the front driver 306 are communicated to the back driver 308 via the request queue 610 or request buffer 614 of the shared memory 408. In a multicore environment, the cores are divided in groups (e.g., pairs) with shared cache (e.g., L2 cache). A distinct request queue 610 per core group is provided in order to take advantage of core parallelism and cache locality. The application thread 602 of the front driver 306 and the filesystem service thread 606 communicate over the request queue 610 of the core group on which they are pinned to run.

An enqueue notification is a synchronization signal that an application thread sends from the front driver 306 to the back driver 308 for a valid request inserted at a specific queue entry. Correspondingly, a service thread at the back driver 308 sends a completion notification to the front driver 306 for a specific completed request. Each entry of the request queue 610 comprises a state field, the enqreq condition variable for the enqueue notification, and a request descriptor structure of the I/O request. In an variation, an I/O argument is large if it is a memory address (e.g., buffer pointer) or data of size exceeding a limit (e.g., 8 bytes). Otherwise, the I/O argument is considered to be small.

Each front-driver thread shares a dedicated request buffer with the back driver for the communication of completion notifications and large data items. The request buffer is located in the shared memory and includes two fields: the complreq condition variable for the completion notification, and the backadd memory address of the request buffer at the back driver. The request descriptor contains the call identifier, the small arguments, the shared-memory identifier (e.g., System V key) of the request buffer, and the backadd memory address.

The request buffer 614 includes two fields—a complreq condition variable for the completion notification and a backadd memory address of the request buffer in the filesystem buffers 608 at the back driver 308.

The first time that the front driver 306 performs an I/O request on behalf of the application thread 602, a one-time cost is incurred to create a new request buffer 614 and map the created request buffer 614 to an application attach address. The front driver 306 also caches a local address (frontadd) of the created request buffer 614 at a thread-local storage for reuse in subsequent requests.

The first time that a back driver 308 receives the I/O request from the application thread 602, the back driver 308 retrieves the shared-memory identifier from the request descriptor and maps the request buffer to a local attach address (backadd). When responding to the I/O request, the back driver 308 copies the backadd address to the request buffer 614. A receiving thread copies the backadd address to the next request descriptor. Accordingly, in subsequent communication between the two threads, the back driver 308 does not need to perform the costly local mapping to retrieve the backadd address.

An application thread 602 invokes an I/O call at the front driver 306 by inserting an entry to the request queue 610. At a synchronous call, the thread waits by spinning up to configurable max tries and sleeping on the complreq field of the request buffer 614. The back driver 308 notifies the waiting thread when the request completes. Thus the program order of the synchronous I/O calls, submitted one after the other is preserved. When the application thread 602 terminates at the front driver 306, the corresponding request buffer 614 is marked as deleted and unmapped from the application address space. Specifically, the back driver 308 maintains and periodically traverses a linked list with all the request buffers 614 mapped to the address space of the filesystem service. Any request buffers 614 marked as deleted by the front driver 306, are unmapped by the filesystem service and deleted by the kernel.

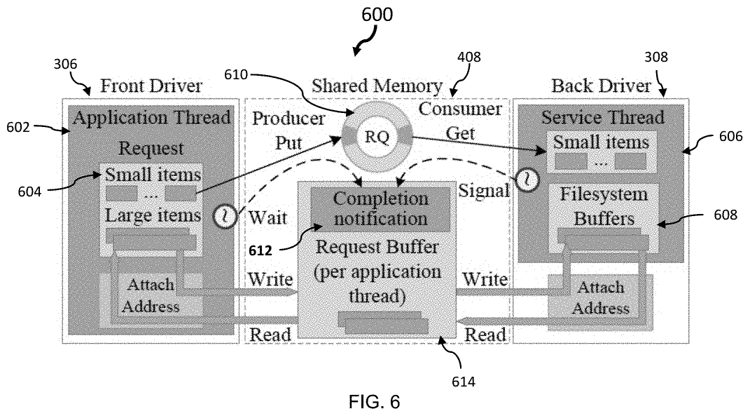

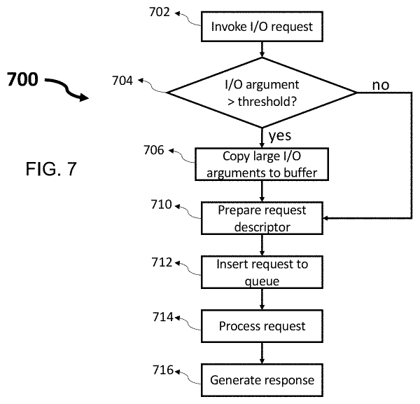

Once the application thread 602 has established the request buffer 614 as described above, an I/O request is served as follows, and as illustrated in FIG. 7. At step 702 an I/O request is invoked. At step 704 it is determined if the I/O argument is greater than a predefined threshold (i.e., if it is “large”). If it is then at step 706, the front driver 306 fills the request buffer 614 with large I/O arguments and continues at step 708. At step 710, the front driver 306 then prepares a new request descriptor including a system call id, small I/O arguments, and the shared-memory id of the request buffer 614. At step 712, the front driver 306 inserts the request descriptor into the request queue 610 and waits for a completion notification 612 through the request buffer 614 to indicate that the request has been completed. At step 714, the back driver 308 retrieves the request descriptor from the request queue 610 and a reference to the I/O arguments in the request buffer 614. The back driver 308 processes the request and copies the response to the request buffer 614. At step 716, the back driver 308 then sends a completion notification 612 through the request buffer 614. In response, the front driver 306 wakes up and copies the response from the request buffer 614 to the application buffer.

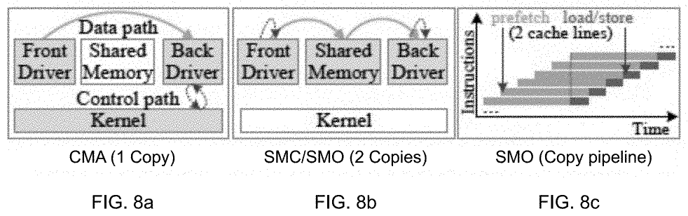

Based on extensive profiling across different systems, the memory copy operation contributes to the measured I/O performance. In one type of memory copy operation, referred to as a cross-memory attach (CMA) method, the front driver 306 uses the request descriptor to pass local addresses of the large I/O arguments to the back driver 308. The back driver 308 uses an existing system call (e.g., Linux process_vm_readv) to directly copy the data between the address spaces of the application and the filesystem service with no kernel buffering. After processing the request, the back driver 308 uses the opposite system call (e.g., Linux process_vm_writev) to directly write the large response items to the application address space. This copy operation is illustrated in FIG. 8a.

In another type of memory copy operation, referred to as a shared-memory copy (SMC), the front driver 306 similarly passes an I/O request as a request descriptor through the queue. However, instead of sending pointers of the I/O arguments to the back driver 308, the front driver 306 copies the I/O arguments to the request buffer, for example using the libc memcpy function. The back driver 308 retrieves the request buffer address, reads the request buffer, processes the request and writes back the response. This copy operation is illustrated in FIG. 8b.

In another type of memory copy operation, referred to as a shared-memory optimized (SMO), the SMC is optimized according to file size. Specifically, an improved memory copy sequence for arguments greater than a predefined file size, such as ≥1 KB for example, is applied. For SMO a pipeline is created having two stages. A first stage prefetches two cache lines into a non-temporal cache structure of the processor. A second stage transfers the two prefetched cache lines to the destination memory address through (eight 128-bit) registers. Five (128-byte) outstanding prefetches are initiated before starting the first memory store in parallel with the sixth prefetch. The PREFETCHNTA instruction is used to prefetch the data, and the SFENCE instruction is used to make the stored data globally visible given the weak ordering of the x86 non-temporal data store. The copy pipelines are illustrated in FIG. 8c. For the Polytropon toolkit, the SMO method appear to achieve higher performance, based on current experimental data. In one form, the memory copy operations were tested on an AMD Opteron 6378. It is expected that other similar processors will similarly benefit after minor adjustments to match their memory channel capacity.

Cross-Platform Optimization: The memcpy performance depends on multiple hardware components with features that vary across different architectures, vendors, and models. In accordance with a variation, the maximum performance per transfer size is identified by applying an exhaustive search over the load, store and register type, and the prefetch size, distance and type. The exhaustive search can be completed offline before starting using the memcpy in normal service, or be executed online every time the memcpy is used during the normal service. Consider, for example, the x86 architecture, which is popular and supports a wide range of instructions, register sizes and prefetch parameters. The search space includes temporal or non-temporal move instructions that support either (i) string data copy with the RSI/RDI address registers, or (ii) SIMD data move through the MMX, XMM, YMM, ZMM data registers of respective size 64, 128, 256 and 512 bits. The load or store core unit implementing a move instruction remains the same across the different data types supported by the hardware (e.g., int, float). Only instructions of one data type are included to increase the performance for specific locality or register settings. The hardware prefetching is automatically initiated when the processor detects a predictable access pattern at a cache level. Instead, the software prefetching flexibly uses special instructions to hint the prefetch of data cache lines. Temporal prefetching may be desirable for data that will be used soon and can fit at the targeted cache line. In contrast, the non-temporal prefetching limits the cache pollution by bringing the data through temporary internal buffers to L1 and reducing the replacement activity at higher cache levels (e.g., L2/L3). The prefetch size is the amount of data fetched by a sequence of prefetching instructions. The prefetch distance is the length in bytes by which the data is requested ahead of its actual load during the memcpy.

Listing 1: Definitions of the Asterope algorithm

| | |
|---|---|
| 1 | #define CLSZ 64 // cache line size (bytes) |
| 2 | #define BSZ (2 * CLSZ) // block size (bytes) |
| 3 | #define MXPS 16 // max prefetch size (blocks) |
| 4 | #define MXPD 16 // max prefetch distance (blocks) |
| 5 | enum op_type = {load_t, load_nt, store_t, store_nt}; |
| 6 | enum prf_type = {prf_t0, prf_t1, prf_t2, prf_nt}; |
| 7 | enum reg_type = {rsirdi, mmx, xmm, ymm, zmm}; |
| 8 | uint xfer_size[ ] = {128, 8KB, 256KB, 1MB, 4MB, 32MB}; |

Listing 2: The Asterope optimization algorithm

| | |
|---|---|
| 9 | asterope (char *to, char *from, uint xfsz[ ]){ |
| 10 | uint xi, bi, ps, pd, pi; |
| 11 | enum prf_type pt; |
| 12 | enum op_type lt, st; |
| 13 | enum reg_type rt; |
| 14 | for (xi = 0 to (sizeof (xfsz) − 1)) // xfer size index |
| 15 | // search for (ps, pd, pt, lt, st, rt) |
| 16 | // with max memcpy performance per xfsz[xi] |
| 17 | for (ps = 0 to MXPS) // prefetch size |
| 18 | for (pd = 0 to MXPD) // prefetch distance |
| 19 | for (pt = prf_t0 to prf_nt) // prefetch type |
| 20 | for (lt = load_t to load_nt) // load type |
| 21 | for (st = store_t to store_nt) // store type |
| 22 | for (rt = rsirdi to zmm) {// register type |
| 23 | // clear cpu caches |
| 24 | // record memcpy duration |
| 25 | for (bi = 0 to ((xfsz[xi] / BSZ) − 1)) { |
| 26 | // prefetch stage |
| 27 | if (ps && !(bi mod ps)) |
| 28 | for (pi = 0 to (ps − 1)) |
| 29 | blkmemprf (from + (pd + pi) * BSZ, pt); |
| 30 | // load and store stages |
| 31 | blkmemcpy (to, from, lt, st, rt); |
| 32 | // next transfer block |
| 33 | from += BSZ; |
| 34 | to += BSZ; |
| 35 | } |
| 36 | // fence for non-temporal store |
| 37 | } |
| 38 | } |

With microbenchmarks, the data throughput of one example cross-platform optimization described above (in offline mode, referred to as Asterope) and other memcpy routines were measured and the results are illustrated in FIG. 20. A pseudo-code implementation of Asterope is shown above as Listings 1 and 2. Data was measured from two machines: (i) a dual-socket server with Intel Xeon processors and 128 GB, and (ii) a quad-socket server with AMD Opteron and 256 GB RAM. The other memcpy routines include Glibc, Linux kernel v5 (Linux5), MusI (v1.2.2), Buffered (using a 4 KB memory buffer) and Polytropon. For each transfer size, the highest performing Asterope configuration is identified by measuring the average throughput over 100 iterations. Similarly, for the other memcpy routines the average throughput reported over 100 iterations. FIG. 20 illustrates the memcpy throughput at different transfer sizes using 1 thread (Debian 11 Linux). Asterope achieves 7.93 GB/s at 256 KB in Xeon, which makes it 1.4× faster than MusI and 1.6× than Glibc and Linux5. In Opteron, the maximum throughput of Asterope is 6.79 GB/s at 256 KB transfer size. The advantage of Asterope is 1.7× over Glibc and 2.5× over MusI at 256 KB, 1.5× over Polytropon at 128B, and even 2.4× over Linux5 at 32 MB. In one form, Asterope prefers the non-temporal instructions and prefetching for Opteron, and a variety of prefetch sizes and distances over the two processor models. With additional sensitivity experiments, it was found that prefetching can improve performance up to 47% in Opteron and 20% in Xeon, while the best choice of register type almost doubles performance.

The system is designed to be implemented on multicore machines with network and storage devices of high speed and low latency. The interaction between an application and a filesystem is a classic communication between a client and a server over shared memory. The producer and the consumer in this system are different processes whose communication should achieve high throughput and low latency at high concurrency. These conditions make a pre-allocated data structure (e.g., a fixed-size array) desirable to a dynamically allocated one. In one form, a pre-allocated data structure supports shared-memory accesses from different address spaces without complex pointer conversions. Also, unlike dynamically allocated data structure, pre-allocated data structure reduces system overhead of frequent dynamic memory allocation. Furthermore, using a pre-allocated data structure reduces processing overhead of update versioning that memory pools require for consistent object recycling. Finally, a pre-allocated data structure keeps memory occupancy over time constant and predictable.

In general, existing systems use concurrent priority queues for communication. A typical choice is a first-in-first-out (FIFO) queue owing to the fact that it reduces starvation by giving priority to data structures with the longest wait time. However, FIFO queues fall short for at least two reasons. First, it is limited in that only one item can be inserted or deleted (from each end of the queue) at a time, thus limiting the number of concurrent operations to two. Second, the correct implementation of the queue operations requires tracking the queue's empty or full condition with state updates that reduce concurrency. It has been suggested that concurrency can be increased in data structures through multiple queues that are inherently sequential due to their FIFO ordering.

Arguably, the actual order of request service in a system depends on several factors beyond the queue priority. First, the time period of request preparation or service execution is determined by the thread scheduling policy. Second, the implementation of the filesystem as consumer introduces delays arising from the locking structure and the data access pattern. Third, the underlying devices also generate delays according to the workload requirements and their scheduling policy. Essentially, the unpredictable system behavior in the service path weakens the relevance of the strict queue ordering. Indeed, the delay increase due to limited queue concurrency may exceed the delay variation due to violation of the strict FIFO order.

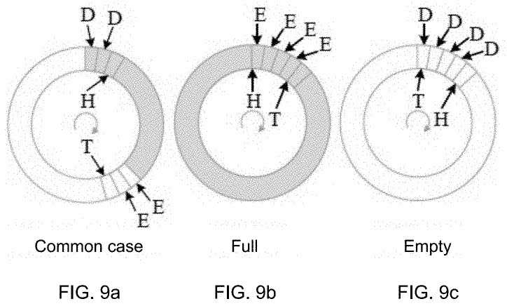

Referring to FIGS. 9a to 9c, a Relaxed Concurrent Queue Blocking (RCQB) algorithm in accordance with an variation is shown. The RCQB comprises one or more dequeuers (D) and/or one or more enqueuers (E). The queue may be neither full nor empty (which is usually the common case) (FIG. 9a), full (FIG. 9b), or empty (FIG. 9c). The shaded region of the queue depicts the presence of items, while the unshaded region depicts the absence of items. The queue includes a head (H) and a tail (T), representing the front and back of the queue, respectively. The RCQB algorithm is provably linearizable with bounded operation reordering. Additionally, it is configured to provide increased performance in the communication between the application and the filesystem.

Each one of the enqueue and dequeue operations are split into two stages. The first stage assigns the operation sequentially into a queue slot, while the second stage completes the operation. In this manner, the operations are distributed across a plurality of slots and allowed to complete in parallel and out of FIFO order. By so doing, not only is a high throughput of the enqueue and dequeue operations achieved, but also, a low wait latency (time period between the arrival and departure of an item from the queue) is achieved.

The RCQB algorithm is implemented as a circular buffer over a fixed-size array. Each array element in the fixed-size array is referred to as a slot and comprises the state field, the enqreq variable, and a request descriptor (item). The tail and head indexes are two integer variables that track the next slot to insert an item at and the next slot to remove an item from, respectively. The array size is set to a power of two (e.g., 256) and overflow of an index variable is treated as an atomic increment with modulo arithmetic. Each slot can have one of four states: (1) free—denotes a state in which a slot is ready to receive a new item; (2) enqpend—denotes a state in which an enqueuer is writing a new item to the slot; (3) deqpend—denotes a state in which a dequeuer is removing an item from the slot; and (4) occupied—denotes a state in which the slot contains valid data ready to be removed.

The enqueue operation consists of four steps: slot allocation, enqpend locking, item insertion, and slot release. The slots are allocated sequentially to the enqueuers by applying a fetch-and-add (FAA) instruction to the tail index. As such, the slot specified by the tail index is allocated before being atomically incremented. The enqueuer atomically reads the state value of the allocated slot. If the state is enqpend or occupied, then the slot is currently being updated by another enqueuer, or it has already received an item. If the state is deqpend, then a dequeuer is currently removing a valid item from the slot. These three cases indicate that the queue is probably full. In anticipation of the slot soon becoming free, the enqueuer pause-spins by staying idle for a brief time period (e.g., through the PAUSE instruction of x86 SSE2) before reading the state value again. If the slot state is free, then the enqueuer attempts to atomically switch the state to enqpend with the compare-and-swap (CAS) instruction. If the CAS fails, then the slot is already occupied or locked by another enqueuer or dequeuer, and the enqueuer reads the state again. When the CAS succeeds, the enqueuer has locked the slot to enqpend and inserts the item. Subsequently, it atomically sets the state to occupied and signals the dequeuer threads (if any) waiting at the slot through the enqreq variable.

The dequeue operation is split into four steps: slot allocation, deqpend locking, item removal, and slot release. The array slots are allocated sequentially to the dequeuers by executing the FAA instruction on the head index. Then, the dequeuer atomically reads the state of the allocated slot. If the state is free, the dequeuer retries up to a limit of times before it will sleep on the enqreq variable of the slot to be woken up by an enqueuer. If the state is enqpend or deqpend, then the slot is locked by an enqueuer or another dequeuer that soon will set it to occupied or free, respectively. In both these cases, the dequeuer pause-spins and reads the state again. If the state is occupied, then the dequeuer attempts to switch the slot state to deqpend through CAS. If the CAS succeeds, then the dequeuer removes the item and atomically sets the state to free. If the CAS fails, then the dequeuer pause-spins and reads the state again.

The enqueuers and dequeuers are assigned to the slots sequentially and updated concurrently. When multiple enqueuers compete at the same time, they are delayed by the speed of incrementing the tail rather than the cost of slot update. Normally an enqueuer is assigned to a free slot with FAA, and proceeds immediately to insert an item with CAS. Finding a slot non-free is possible when the number of enqueuers approaches the queue size, or the enqueuers insert items faster than the dequeuers remove them. Then, the enqueuers retry until the slot becomes free, instead of being redirected to use another slot.

Similarly, the dequeuers are assigned to slots at the speed of incrementing the head. Normally, the head remains behind the tail, and the dequeuers immediately remove items from the occupied slots. If the item arrival is slower than the item departure, or the number of dequeuers approaches the queue size, then the head catches up with or moves ahead of the tail. Then, the dequeuers are assigned to non-occupied slots and retry or sleep instead of being relocated to a different slot. The retry with pause-spin by the enqueuers and dequeuers leads to stable behavior and high performance. On the contrary, the relocation to a different slot can lead to increased delays and substantial performance variation in several cases.

In the unlikely case that a thread fails while it occupies a slot in the enqpend or deqpend state, then any other threads assigned to the same slot are blocked. The threads that operate at the remaining slots continue their normal progress. In the worst case, all the enqueuers and dequeuers will end up blocked in the locked slot of the failed thread. This is a consequence of the blocking operation that typical blocking queues do not address. RCQB handles it gracefully in the sense that only the threads assigned to the locked slot are affected. Additionally, each tenant of the Polytropon toolkit uses separate filesystem services, and each filesystem service operates separate queues across the different core groups. The case of thread failures during queue accesses is addressed by non-blocking algorithms, such as, e.g., those presented in in paragraphs [0134]-[0135] and Listing 6.

Listing 3: Data structures of the RCQ algorithms

| | |
|---|---|
| 1 | struct slot { |
| 2 | // fields in distinct cache lines |
| 3 | state: int (32 bits) // state/condition variable |

// initially FREE

| | |
|---|---|
| 4 | data: int (64 bits) // value or pointer (in RCQS it includes |

// the 1-bit state)

| | |
|---|---|
| 5 | waiters: uint (32 bits) // initially 0 |
| 6 | } |
| 7 | struct rcq { |
| 8 | // fields in distinct cache lines |
| 9 | slots[N]: struct slot // N = 2ⁿ (e.g., n = 8) |
| 10 | head: uint (16 bits) // uint of byte-multiple size, |
| | // initially 0 |
| 11 | tail: uint (16 bits) // uint of byte-multiple size, |
| | // initially 0 |
| 12 | } |

Listing 4: Enqueue and Dequeue of blocking RCQB

| | |
|---|---|
| 13 | int enqueue(q: pointer to rcq, d: int){ |
| 14 | locTail: uint (16 bits) |
| 15 | locState: int (32 bits) |
| 16 | |
| 17 | locTail := atomicInc(&q→tail) & (N−1) // enq_assign (line 17) |
| 18 | while (true) { |
| 19 | locState := atomicLoad(&q→slots[locTail].state) |

// enq_update (lines 19-28)

| | |
|---|---|
| 20 | if (locState = FREE) { |
| 21 | if (CAS(&q→slots[locTail].state, FREE, ENQPND) = true) { |
| 22 | q→slots[locTail].data := d |
| 23 | atomicStore(&q→slots[locTail].state, OCCUPIED) |
| 24 | wakeDeq(&q→slots[locTail]) |
| 25 | return(0) // successful enqueue |
| 26 | } |
| 27 | } |
| 28 | spinPause |
| 29 | } |
| 30 | } |
| 31 | int dequeue(q: pointer to rcq){ |
| 32 | locHead: uint (16 bits) |
| 33 | locState: int (32 bits) |
| 34 | locData: int (64 bits) |
| 35 | |
| 36 | locHead := atomicInc(&q→head) & (N−1) // deq_assign (line 36) |
| 37 | while (true) { |
| 38 | locState := atomicLoad(&q→slots[locHead].state) |

// deq_update (lines 38-50)

| | |
|---|---|
| 39 | if (locState = OCCUPIED) { |
| 40 | if (CAS(&q→slots[locHead].state, OCCUPIED, DEQPND) = |

true) {

| | |
|---|---|
| 41 | locData := q→slots[locHead].data |
| 42 | atomicStore(&q→slots[locHead].state, FREE) |
| 43 | return(locData) // successful dequeue |
| 44 | } |
| 45 | } |
| 46 | else if (locState = FREE) { |
| 47 | waitEnq(&q→slots[locHead], FREE) |
| 48 | continue |
| 49 | } |
| 50 | spinPause |
| 51 | } |
| 52 | } |

Listing 5: WakeDeq and WaitEnq of RCQ

| | |
|---|---|
| 53 | wakeDeq(s: pointer to slot){ |
| 54 | if (s→waiters >0) { |
| 55 | wake(&s→slots[locTail].state) |
| | // wake up all dequeuers of s |
| 56 | } |
| 57 | } |
| 58 | waitEnq(s: pointer to slot, v: value){ |
| 59 | i: int (64 bits) |
| 60 | |
| 61 | for (i :=0 to MAXSPINS) { |
| 62 | if (s→state = v) { spinPause } |
| 63 | else { return } |
| 64 | } |
| 65 | atomicInc(&s→waiters) |
| 66 | while (s→state = v) { |
| 67 | // atomically load, check, and sleep if state = v |
| 68 | wait(&s→state, v) // wait on futex variable for enqueuer |
| 69 | } |
| 70 | atomicDec(&s→waiters) |
| 71 | } |

Other variations can be derived using the two-stage operation model described above. For example, in the following, a linearizable and lock-free algorithm referred to as a Relaxed Concurrent Queue Single (RCQS) is disclosed along with a variation of it referred to as a Relaxed Concurrent Queue Double (RCQD).

The RCQS data structure also consists of a fixed-size array called slots, and two unsigned integers called head and tail. The array is organized as a circular buffer. The array size (256 by default) is limited to powers of two so that the queue indexes can be atomically incremented and overflow to the start of the array. A slot element of the array consists of the state and the data fields. The state field is both an integer identifier of the current state and a condition variable that notifies a waiting dequeuer for a new item enqueue. The data field can be a 63-bit value or a properly-aligned pointer. A compare-and-swap (CAS) instruction atomically sets both the state and data fields in a 64-bit variable. The RCQS uses a single CAS instruction as opposed to CAS2. The buffer pointer should be aligned to an address that is a multiple of 2 to leave the least significant bit for the slot state. In contrast, the RCQD (D for double) refers to a linearizable and lock-free algorithm that uses the CAS2 instruction to atomically set both the slot state and data fields. The two fields are stored in two distinct 64-bit variables instead of one, thus making the address alignment of the buffer pointer unnecessary. In either the RCQS or the RCQD algorithm, the slots allocated to the enqueuers and dequeuers are specified by atomically incrementing the tail and head indexes respectively with a fetch-and-add (FAA) instruction. As an implementation example, the pseudo-code of an RCQD algorithm is provided in Listing 6. For the sake of clarity and ease of understanding, only the algorithm RCQS is described and evaluated in the following paragraphs.

Listing 6: Enqueue and Dequeue of lock-free RCQD

| | |
|---|---|
| 72 | int enqueue(q: pointer to rcq, d: int){ |
| 73 | locTail: uint (16 bits) |
| 74 | locState: int (32 bits) |
| 75 | locData: int (64 bits) |
| 76 | |
| 77 | locTail := atomicInc(&q→tail) & (N−1) |

// enq_assign (line 77)

| | |
|---|---|
| 78 | while (true) { |
| 79 | locState := atomicLoad(&q→slots[locTail].state) |

// enq_update (lines 79-87)

| | |
|---|---|
| 80 | locData := atomicLoad(&q→slots[locTail].data) |
| 81 | if (locState = FREE) { |
| 82 | if (CAS2(&q→slots[locTail], &locState, &locData, |

OCCUPIED, d) = true) {

| | |
|---|---|
| 83 | wakeDeq(&q→slots[locTail]) |
| 84 | return(0) // successful enqueue |
| 85 | } |
| 86 | } |
| 87 | spinPause |
| 88 | } |
| 89 | } |
| 90 | int dequeue(q: pointer to rcq){ |
| 91 | locHead: uint (16 bits) |
| 92 | locState: int (32 bits) |
| 93 | locData: int (64 bits) |
| 94 | |
| 95 | locHead := atomicInc(&q→head) & (N−1) |

// deq_assign (line 95)

| | |
|---|---|
| 96 | while (true) { |
| 97 | locState := atomicLoad(&q→slots[locHead].state) |

// deq_update (lines 97-107)

| | |
|---|---|
| 98 | locData := atomicLoad(&q→slots[locHead].data) |
| 99 | if (locState = OCCUPIED) { |
| 100 | if (CAS2(&q→slots[locHead], &locState, &locData, FREE, |

0) = true) {

| | |
|---|---|
| 101 | return(locData) // successful dequeue |
| 102 | } |
| 103 | spinPause |
| 104 | } |
| 105 | else{ |
| 106 | waitEnq(&q→slots[locHead], FREE) |
| 107 | } |
| 108 | } |
| 109 | } |

As stated earlier, the slot state can only take two values, free or occupied. An enqueuer attempts to switch the slot state from free to occupied and simultaneously update the slot data. If the CAS succeeds, the slot update completes and the operation returns 0. Otherwise, the slot is occupied or another thread already completed CAS, in which case the enqueuer retries at the same slot. A dequeuer attempts to switch the state from occupied to free and simultaneously set the value to 0. The CAS operation completes if the initial state is occupied and the data is equal to the last retrieved value of the slot. If the CAS succeeds, the operation returns the retrieved data. If the state is occupied but the CAS failed, then another dequeuer successfully executed CAS and the current dequeuer retries at the same slot. If the slot state is already free, then the dequeuer sleeps after a maximum number of retries. RCQS is a linearizable, lock-free queue algorithm that utilizes a limited amount of memory space and achieves substantially lower operation and wait latency than existing algorithms. The relaxed operation ordering combined with the lock-free synchronization improve the operation concurrency and allow the items to depart faster from the queue.

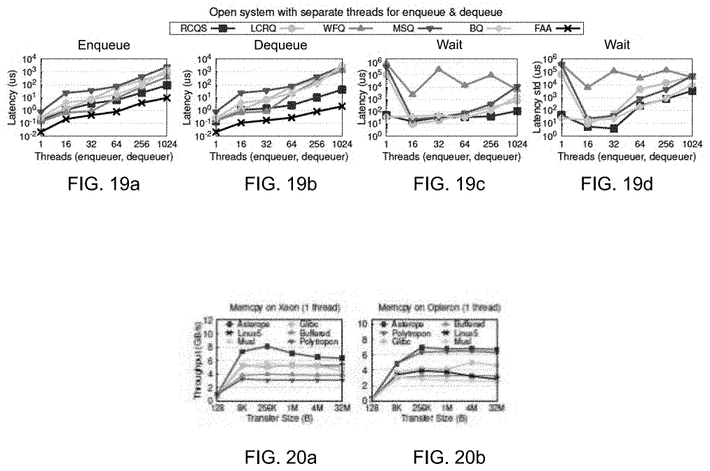

Example experimental results for the RCQS are illustrated in FIGS. 19a to 19d. Measurements were made on a server with two 16-core Intel Xeon Gold 5218 (Cascade Lake) processors (2.3 GHz, 22M L3 cache) and 128 GB RAM running Debian 11. The Linux kernel v5.4.0, and the tcmalloc memory allocator from Google were used. The comparison compares the RCQS described above with known algorithms such as the lock-free LCRQ, the wait-free queue (WFQ), the blocking Broker Queue (BQ), and the lock-free list-based queue (MSQ). As a baseline of low cost, the execution of an FAA instruction is included without any queue. In the array-based algorithms, a default queue size of 256 was used.

An open system is provided in which the enqueuers send items to dequeuers without waiting from them to reply back. Dedicated enqueue and dequeue threads invoke back-to-back operations of a single type. Equal numbers of enqueue and dequeue threads are used and the threads are pinned round-robin to the hardware cores. Each experiment generates 10M separate enqueue and dequeue operations. The reported enqueue or dequeue latency spans the time period from the first attempt of the thread to perform the operation until the successful completion. The operation may involve multiple retries according to the algorithm used. The wait latency of an item is the time period from the item arrival to the item departure from the queue. With the RCQS relaxed ordering, the wait latency is reduced by keeping both the queue operation latencies low and also the time that an item spends occupying a slot in the queue.

Referring to FIG. 19a, the enqueue latency of RCQS is up to 9.5× lower than LCRQ, 16.5× than BQ, and 27.7× than MSQ, but higher than WFQ at ≤32 threads. It is shown in FIG. 19b, RCQS has lower dequeue latency than the other algorithms, such as 30.6× below WFQ and 34.9× below LCRQ. The dequeuers of WFQ and LCRQ search for a slot with inserted indexed item, the dequeuers of WFQ help other threads before completing their own operation, and BQ is slower at empty or full queue.

In comparison to FAA, the operations of RCQS take 5-19× longer, due to the atomic access instructions and CAS. The RCQS line remains at the bottom of FIGS. 19c and 19d with average wait latency 16-114 μs and standard deviation up to 3.4 ms. At 1 thread, the wait latency and standard deviation of LCRQ, WFQ and MSQ reach tens or hundreds of milliseconds due to their enqueuer-dequeuer contention, or the peer inspection by WFQ before returning the empty error. Similarly, the wait latency and standard deviation of LCRQ, WFQ, BQ and MSQ spike at 256 or 1024 threads due to the enqueue retries or queue creations triggered by a full queue. Several RCQS variations (e.g., blocking, non-blocking with CAS2) were evaluated and found to perform comparably or better than existing algorithms.

As will be appreciated, variations can be made to the RCQB and RCQS algorithms described above with minor modifications. In one form, as mentioned above, in the algorithm referred to as RCQD it is possible to use the CAS2 hardware instruction (instead of CAS) in order to atomically modify both the value and the state of a cell respectively stored in two different variables (instead of one). Additionally, it is possible to modify the array size from 256 slots to other multiples of 2, smaller or larger. Alternatively, one can count the current number of enqueue and dequeue operations (or difference thereof) that arrived to the data structure in order to support the empty and full Boolean operations. Finally, when an operation is unsuccessful at the current slot, one can retry it at the next slot until it succeeds.

The container pool of a tenant mounts the filesystems and specifies the namespaces and resource usage limits of the containers running on a host. The container pools and the containers therein are managed according to the parameters of their configuration files through an API of create, start and stop commands.

The container engine is a standalone process that manages the container pools of a host. Its functions include isolating the resource identifiers of a container pool with namespaces, specifying the processor cores and memory nodes with the cpuset controller (cgroup v1), and limiting the memory usage with memory controller (cgroup v2). The clone call is used in creating namespaces and in launching the first process of a new container pool. The container processes are forked from the first process and inherit the namespaces of the container pool or create new namespaces nested underneath (e.g., PID, UID). The cgroup hierarchy provides a dedicated subtree for each container pool to monitor and limit resource usage. The controllers and processes of a container are attached to a leaf node of the subtree if the controllers are distinct from those of the container pool; otherwise, they are attached to the root of the subtree.

The storage driver mounts a root or application filesystem to a subset of the pool processes. The filesystems are categorized by the user or kernel level of their execution or IPC (four combinations). The default filesystems of the Polytropon toolkit are filesystem instances constructed from stacks of user-level libservices accessible through both the user and kernel level. For the experimental comparison with existing systems or other purposes (e.g., backward compatibility), the container engine can also mount traditional filesystems based on kernel modules. These filesystems are accessed through the kernel and run at user or kernel level (e.g., VFS).

The Polytropon components described above were used to build a distributed filesystem client referred to as Danaus. Each Danaus client is a filesystem instance consisting of a union libservice stacked over a Ceph libservice. An application communicates with a Danaus client through the default filesystem library over shared memory, or through a legacy FUSE-based kernel path. A pool can initiate an arbitrary number of Danaus clients, each with its own cache shared across the processes that mount it.

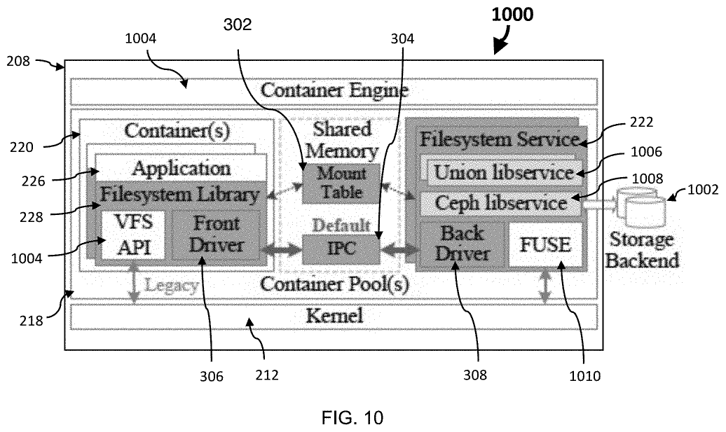

Referring to FIG. 10, a block diagram of an example Danaus client is shown in accordance with the subject disclosure and is generally identified by reference numeral 1000. Host 208 is in communication with a storage backend 1002. The host 208 comprises a container engine 1004, one or more container pools 218, and the kernel 212. The container pool 218 comprises one or more containers 220, the shared memory 408, and one or more filesystem services 222. Each container 220 in the container pool 218 comprises one or more applications 226 and one or more filesystem libraries 228, each application 226 associated with a respective filesystem library 228. Each filesystem library 228 includes a Virtual File System (VFS) API 1004 and the front driver 306.

The shared memory 408 of the container pool comprises a mount table 302 and the IPC 304.

Each filesystem service 222 in the container pool 218 comprises one or more union libservices 1006, one or more Ceph libservices 1008, a back driver 308 and File System in Userspace (FUSE) 1010. The union libservices 1006 and Ceph libservices 1008 are collectively referred to hereinafter as Danaus client.

An arbitrary number of Danaus clients can be initiated by the container pool 218. Each Danaus client initiated by the container pool 218 has its own cache which is shared across the applications that mount that particular Danaus client. The union libservices 1006 of each Danaus client are derived from the unionfs-fuse filesystem based on FUSE, however, the unionfs-fuse is modified to invoke libservice API rather than FUSE API. Correspondingly, the Ceph libservices 1008 of each Danaus client is derived from libcephfs library to provide POSIX-like interface to the Ceph distributed filesystem. The Ceph libservices 1008 is configured to support memory object cache of data, inodes, and directories and the network access of the object storage servers and metadata servers.

An application 226 running in the container 220 communicates with a Danaus client through the filesystem library 228 over shared memory 408, or through a legacy FUSE-based kernel path.

The application filesystem or the root filesystem can be constructed from a combination of basic filesystems, such as: (i) Polytropon filesystem instance consisting of a union libservice over the client libservice of a distributed filesystem, like in the present case. By so doing, the filesystem instance runs at user level inside a filesystem service accessed from the user level for isolation, or through the kernel for compatibility; (ii) a legacy filesystem constructed from a union filesystem (e.g., AUFS) over a local filesystem (e.g., ext4), with the path and execution of both at kernel level; (iii) a legacy filesystem composed of a FUSE-based union over a kernel-level client of a distributed filesystem. Although the FUSE union runs at user level and the client at kernel, the IPC paths of both pass through the kernel. A filesystem instance is mounted through the Polytropon filesystem service, unlike a traditional filesystem mounted through the system kernel.

The performance of the Polytropon was evaluated through several experiments. In one form, the experiments were designed to evaluate:

how fast Polytropon, FUSE and kernel serve the multitenant host I/O network storage;

the comparative performance of serving cloned containers of a tenant over shared network storage;

the extent to which IPC queue algorithm affects application performance over network storage;

the enqueue latency and end-to-end throughput of RCQB in comparison to other known queues;

how SMO benefits Polytropon over SMC and CMA;

how the IPC of Polytropon compare to that of FUSE; and

how the core utilization by the shared kernel affects the I/O isolation among competing workloads.

The experiments were conducted on two identical x84-64 machines of 4 sockets with 16-core AMD 6378 processor clocked at 2.4 GHz. Each machine has 64 cores, 256 GB RAM and 20 Gps bonded connection to a 24-port 10 GbE switch. The local storage includes 2 SAS disks in RAID1 for the host root filesystem. The machines run Debian 9 Linux (kernel v4.9). As will be appreciated by one of skill on the art, the experiments can be performed on other processors or operating-system kernels without deviating from the spirit of the present disclosure. For instance, the experiments have been performed on Intel Cascade Lake and kernel version (v5.4), both of which shows similar results.

On the client machine, Linux cgroups and namespaces were used in configuring the containers running on the host. The server machine comprises 8 cores and 32 GB RAM to run the host system, and 7 VMs (Xen v4.8) of 32 GB RAM and 8 cores to run 6 object storage devices (OSDs) and 1 Metadata Server (MDS) of Ceph (v10.2.7). On each OSD, 8 GB of RAM is used for main memory and 24 GB of RAM as ramdisk with XFS to store the OSD data and journal at high performance. In the experiments, several standard or custom-developed tools were employed, including RocksDB, Filebench (v1.5-alpha3), GAP Benchmark Suite (v1.2). Unless otherwise specified, the experiments were repeated as desired to get half-length of the 95% confidence interval of the parameter of interest (e.g., throughput) to within 5% of the measured average.

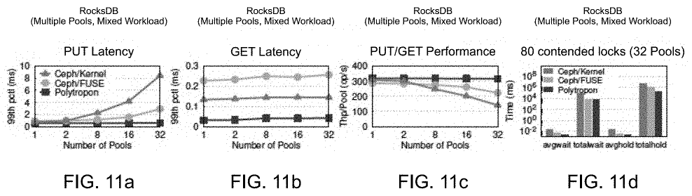

Referring to FIGS. 11a to 11d, the experimental results obtained from running RockDB storage engine over Polytropon, FUSE and kernel-based clients are shown.

Referring to FIG. 11a, the 99th percentile of the put latency as a function of the number of container pools for the Polytropon, FUSE and kernel-based clients is shown. As can be seen, the put latency for the Polytropon-based client is independent of the number of container pools, and is estimated to be within 3% of 580 μs. On the other hand, the put latency for the FUSE and kernel-based clients increases as the number of container pools is increased. The put latency for the FUSE-based client is estimated to be about 1.6-4.8 times that of the Polytropon-based client, while that of the kernel-based client is estimated to be about 1.3-14 times that of the Polytropon-based client.

Referring to FIG. 11b, the get latency as a function of the number of container pools for the Polytropon, FUSE and kernel-based clients is shown. As can be seen, the get latency for the three clients does not vary much as the number of container pools is increased, yet, the get latency for the Polytropon-based client is consistently lower than that for the FUSE and kernel-based clients. In one form, the get latency for the FUSE and kernel-based clients are between 3-4 times greater than those of the Polytropon-based client.

Referring to FIG. 11c, the average put/get throughput per container pool for the Polytropon, FUSE and kernel-based clients is shown. As can be seen, the throughput for the Polytropon-based client is independent of the number of container pools. On the other hand, the throughput for the FUSE and kernel-based clients decreases as the number of container pools is increased. In one form, the throughput for the FUSE-based client decreased about 23% between 1 container pool and 32 container pools. Similarly, the FUSE-based client decreased about 54% between 1 container pool and 32 container pools.

Referring now to FIG. 11d, the average/total lock wait and hold times for running RocksDB over Polytropon, FUSE and kernel-based clients for 32 container pools is shown. As can be seen, the hold and wait times for the FUSE and kernel-based clients are one order of magnitude higher than those for the Polytropon-based client. This is because, unlike Polytropon, the FUSE and kernel-based clients involve shared data structures of the system kernel in I/O transfer (handling), despite each container pool being served by a separate FUSE process or kernel mount.

In another experiment, the Polytropon, FUSE and kernel-based clients are deployed in running data-intensive applications and the timespan to start and run container in each one of the clients is measure. In one example, data-intensive application is GAP benchmarking suite (a graph processing benchmark suite), however, any suitable data-intensive application can be used.

The Breadth-First Search (BFS) algorithm is run on a directed graph labeled with distances of all roads in the U.S. (1.3 GB). Each container pool mounts a separate root filesystem from Ceph and executes one container. The BFS algorithm performs calculations on a graph built in memory with the edge lists retrieved from the container.

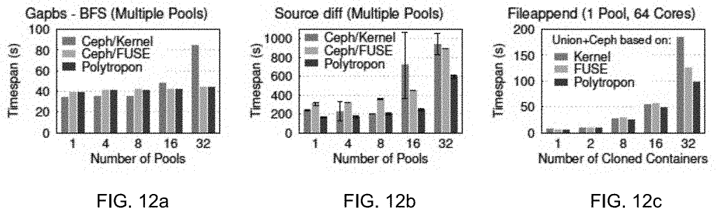

Referring to FIG. 12a, the timespan to start and run container with Gabps is shown. As can be seen, the timespan for the Polytropon and FUSE-based clients is within the range 38-44 s and almost independent of the number of container pools for up to 32 container pools. In contrast, the timespan for the kernel-based client increased from 33 s to 84 s as the number of container pool increased from 1 to 32. This increase in timespan for the kernel-based client is attributed to the longer I/O time to read the edge lists. By profiling the system kernel, it was found that the kernel-based client is slowed down by the wait time on spin lock of the LRU page lists. The Polytopron-based client overcomes this situation by providing separate filesystems per container pool at user level.

Referring to FIG. 12b, the timespan to start and run container with source code diff is shown. The error bar represents the standard deviation in the result. As can be seen, as the number of pools is increased, the FUSE-based and the kernel-based client take up 1.9 times and 2.9 times, respectively, longer than the Polytropon-based client. This implies that the I/O kernel path of the FUSE-based and the kernel-based clients causes higher delays. Furthermore, the figure shows that the standard deviation for the kernel-based client is about 32.6 times that of the Polytropon-based client. This implies that the kernel I/O handling causes substantial performance variability.

In another example, the scaleup setting of running several cloned containers in one container pool over a shared filesystem is evaluated. In this example, 64 cores and 200 GB of RAM is allocated to the container pool and 64 GB is allocated to the host. Each container in the container pool mounts a separate root filesystem comprised of a writable branch over a read-only shared branch. The branches are maintained by a separate union filesystem per container over a shared Ceph client per pool. The systems of interest in this example are: (i) Danaus implemented by union and Ceph libservices of Polytropon, (ii) union filesystem and Ceph client implemented with FUSE, (iii) union(AUFS) and Ceph (CephFS) implemented by kernel modules. All three systems rely on the union and shared cache to fetch a single copy of the container image to the host memory. Yet, the Polytropon and FUSE-based client use the object cache of the shared Ceph client running at user level, while the kernel-based system uses the system page cache. Over the container root filesystem, a custom-developed Fileappend benchmark open a cloned 2 GB file in write/append mode, appends 1 MB, and closes it.

Referring to FIG. 12c, the timespan to start and run container with the Fileappend workload is shown. As can be seen, when compared to the Polytropon, the FUSE-based and kernel-based client take 28% and 88% longer to start and execute the 1 to 32 container(s) of the container pool in parallel, respectively. The generated I/O is 50-50 read/write because the union filesystem copies the file from the read-only to the writable branch before executing the append. This further corroborates the argument that it is advantageous to carry out the communication and filesystem serving at user level instead of having one or both running inside the kernel.

The IPC queue of the toolkit critically affects the performance of the applications running over Polytropon. Broker Queue (BQ) is a state-of-the-art array-based blocking algorithm improved for massively parallel systems (e.g., GPUs). On the contrary, the list-based Two-Lock Queue (TLQ) is a baseline algorithm with one enqueuer and one dequeuer allowed to modify the queue in parallel. Alternatively, one may implement the Polytropon IPC with the RCQB, BQ or TLQ queue. In a pool with 64 cores and 200 GB RAM, the Filebench Singlestreamread (Seqread) is run with 1-512 threads for 120s on 1 GB file. The file is stored in the container root filesystem mounted from Ceph through Polytropon. The enqueuer and dequeuer threads of Polytropon belong to distinct application and service processes, respectively, as such queue algorithms designed for one process (e.g., LCRQ and WF) are fully compatible. For high concurrency, the benchmark I/O size was set to 1KB and a single queue was used to connect the benchmark application with the filesystem service.

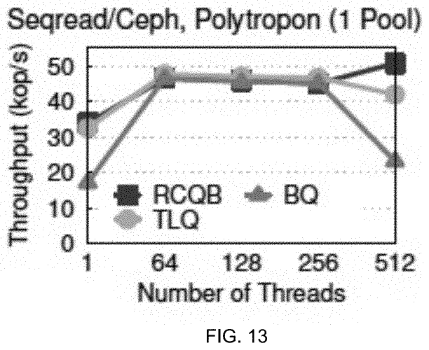

Referring to FIG. 13, the application performance of running Filebench Singlestreamread (Seqread)/Ceph across RCQB, Broker Queue (BQ), and Two-Lock Queue (TLQ) is shown. As can be seen, all three algorithms perform well at 64-256 enqueuer or dequeuer threads (128-512 total). However, at 1 or 512 threads per operation type, the throughput of BQ drops to half of RCQB or less. This is expected because BQ requires a long execution path to handle an empty or full queue. At 512 threads, the TLQ coarse-grain locking leads to 21% lower throughput than RCQB.

Furthermore, additional state-of-the-art algorithms have been examined with a number of dedicated enqueue and dequeue threads running in one process over a single queue. In one form, RCQB, the lock-free LCRQ, the wait-free WFQ, and the blocking BQ have been examined. The workload runs 10M enqueue and dequeue operations in a closed system. An enqueuer sends a synchronous request item and the dequeuer responds with a completion notification immediately after extracting the item from the queue.

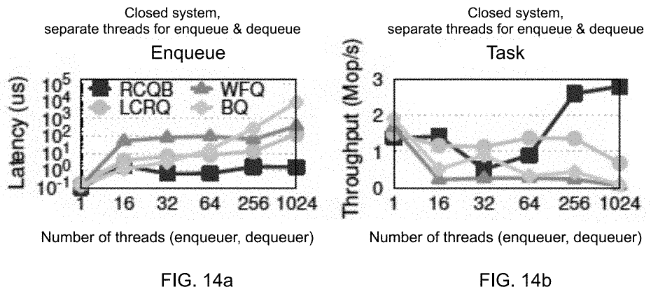

Referring to FIGS. 14a and 14b, the average enqueue latency and throughput of synchronous tasks over RCQB, LCRQ, WFQ and BQ are shown.

As can be seen in FIG. 14a, the average enqueue latency of RCQB gets up to 1.6 μs at 1024 threads, while that of LCRQ, WFQ and BQ is 77×, 246× and 5881× higher, respectively.

In FIG. 14b, task throughput of synchronous tasks. The task throughput is defined as the rate at which the enqueuers receive completions from the dequeuers. This metric encompasses the item communication between the enqueuers and dequeuers including the wait latency through the queue. As can be seen, at 32 threads, LCRQ is up to 2.2× faster than RCQB, but at 1024 threads, RCQB is faster 4× over LCRQ, 34× over BQ and 52× over WF. The higher task throughput of RCQB follows from the parallel completion of the enqueue and dequeue operations, which results into improved concurrency over the strict FIFO ordering of LCRQ, WFQ and BQ. The advantages of RCQB over the other algorithms is evident in other metrics (e.g., tail latency) and unbalanced thread counts. RCQB combines low operation latency with high communication throughput. This may make it a desired choice, especially for multicore systems with high concurrency.

The performance impact of the CMA, SMC and SMO data transfer methods have been compared by running a data-intensive application over network storage mounted through Polytropon. On a host with 8 enabled cores, sequential reads over Ceph are generated by running the Filebench Seqread with 64 threads on 1 GB file.

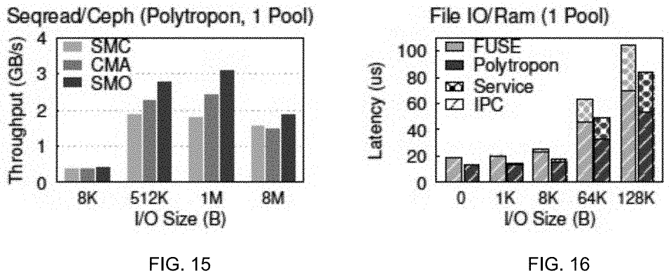

Referring to FIG. 15, the data transfer rate with Shared Memory Optimized (SMO), Cross-Memory Attach (CMA) and Shared-Memory Copy (SMC) are compared. As can be seen, the throughput for SMO (with a maximum of 3.1 GB/s) is consistently higher than those of CMA (maximum of 2.4 GB/s) and SMC (maximum of 1.9 GB/s). SMO performs 2 memory copies instead of 1 with CMA and runs at user level rather than inside the kernel. Nevertheless, the benefit from the pipelined operation makes SMO 66% faster than SMC and 29% faster than CMA.

The performance difference between user-level path of Polytropon and the kernel-level path of FUSE is compared by placing the same filesystem functionality at the service side. In a pool of 8 cores and 32 GB RAM, a trivial local filesystem with memory buffering is implemented. The benchmark opens a file, invokes a read 1M times, and closes it. For read I/O size in the range 0-128 KB, the average read latency (lower is better) broken down into IPC and service time is examined.

Referring to FIG. 16, the cost of running (latency) Polytropon and FUSE for different I/O size is compared. As can be seen, in comparison to Polytropon, FUSE takes 25%-46% longer to serve the read due to 32-46% higher IPC time. It may be concluded that handling the IPC through SMO at user level makes Polytropon faster than FUSE.

The effect of core utilization by the kernel on the I/O performance isolation has also been explored. In this experiment, the container is configured with 2 cores and 8 GB RAM to run the Stress (stress-ng) benchmark with random 512B reads/writes on 2 local disks in RAID0. Four cores were activated at the client machine and a Fileserver (Filebench) container of 2 cores and 8 GB RAM either alone or next to the Stress container was run.

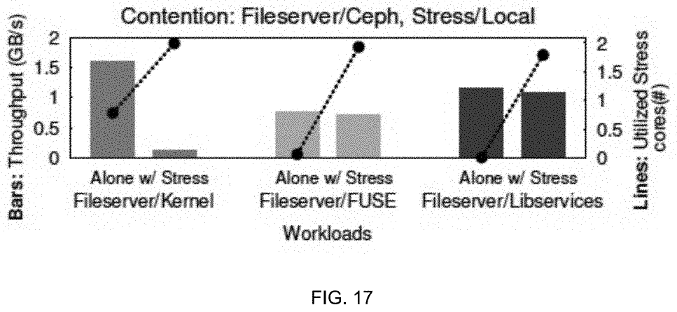

Referring to FIG. 17, the performance of the kernel, FUSE- and Libservice-based client with and without Stress is shown. As can be seen, fileserver throughput drops by factor of 12.9× when the kernel Ceph client runs in parallel to Stress. In contrast, the fileserver throughput with FUSE or libservices drops less than 7%. The kernel-based fileserver performance varies substantially next to Stress because the respective I/O utilizes all the 4 enabled cores (including those of Stress) rather than only those reserved for the fileserver.

The Fileserver throughput over the Ceph client based on kernel, FUSE, and libservices was examined. The Fileserver container was configured with 2 cores and 8 GB using cgroups. The remaining cores (up to 62) were left unallocated, and the system settings was used to enable a total of 2, 16 or 64 cores in the client host. The container runs on a root filesystem stored on the Ceph servers.

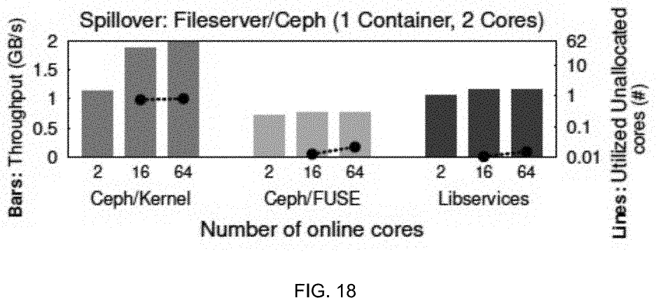

Referring to FIG. 18, the performance of the Ceph/kernel, Ceph/FUSE and Libservices is shown. As can be seen, increasing the enabled cores of the client host from 2 to 64 raises the kernel I/O throughput by 75%, but only 5-8% the throughput of FUSE and libservices. The lines of the cpu utilization show that the kernel achieves higher Fileserver performance because it runs the flusher threads on cores that cgroups did not allocate to the Fileserver container. Indeed, the system kernel handles the container I/O with all the available cores. In contrast, a user-level I/O system only utilizes the cores allocated to the served containers.

As such, it is conclusive that the tenant I/O performance can be isolated by running the filesystem functionality at user level on the reserved resources of the container pool. Although both FUSE and libservices run the filesystem at user level, libservices achieve higher performance because it completely bypasses the kernel. The efficacy of libservices can be further demonstrated by building the storage servers on libservices and allocate distinct resources per tenant at both the client and the server machines.

By providing per-tenant provisioning of user-level filesystem on a host, variations disclosed herein provides that multiple processes efficiently connect with the shared filesystem of a tenant through user-level interprocess communication. Second, the filesystem is configured to coordinate state consistency across multiple concurrent operations. Third, the filesystem is flexibly configured to provide deduplication, caching and scalability across the tenant containers. Fourth, the application interface preserves the semantics of standard system calls over file descriptors, reference counts and other objects. The system calls with implicit I/O (e.g., exec) communicates with the filesystem through the traditional kernel I/O path for compatibility.

In summary, the Polytropon toolkit achieves scalable storage I/O over a stock kernel in order to serve the data-intensive containers of multitenant hosts. It consists of reusable user-level components that provision composable filesystems per tenant and connect them to multiple container processes. The filesystem configuration and the host I/O path of a container pool are isolated from the kernel and other pools.

The container pool is used here as a broader concept that covers all the containers of a tenant sharing namespaces and storage resources in a machine.

The IPC is improved with a relaxed concurrent queue (RCQB) and a pipelined memory copy (SMO). Union libservice is combined with a Ceph filesystem client libservice to build the Danaus filesystem client. In comparison to highly-optimized filesystems running at user or kernel level, Danaus increases the performance of a storage engine and executes faster several cloned or independent data-intensive containers.

The experimental results presented show that libservices can also be used in supporting network block volumes and local filesystems (e.g., LKL), as the monitored allocation of the pool resources could enable their non-trivial overcommitment for reduced tenant cost.

When configuring multitenant environments, network specialists often face the dilemma of whether to favor performance over utilization. It turns out that aggressive resource utilization leads to high performance variability especially with I/O-intensive applications. The proposed I/O isolation is the first step toward flexible resource management that guarantees the tenant reservations and provides additional resources dynamically as they become available per machine. It is possible to anticipate the interactive serving jobs typically running on reserved hardware resources to benefit the most from the improved storage isolation achieved by libservices.

Admittedly, most of the existing user-level storage libraries are less mature than their kernel counterparts. Their wider use may encourage their further development and optimization. Their improvement will facilitate the dynamic readjustment of the allocated resources (e.g., cache memory) and the accurate online monitoring of the utilization effectiveness. The user-level IPC could benefit from efficient memory copy that takes advantage of the latest processor advances.

From one example design and experimental results, the libservices are an I/O service abstraction that enable dynamic provisioning of container storage systems and isolates I/O performance among competing tenants.

Although variations have been described above with reference to the drawings, those of skill in the art will appreciate that other variations and modifications may be made without departing from the scope of the present disclosure as defined by the appended claims.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A shared computing system for serving a plurality of tenants, the computer system comprising:
a container pool for each of the plurality of tenants, each container pool comprising:
a container including an application;
a filesystem service configured to service the application; and
a shared memory configured to facilitate interprocess communication between the application and the filesystem service,
wherein the application, the interprocess communication and filesystem service are run at a user level.

2. The shared computing system of claim 1, wherein the container pool is used for dynamically provisioning one or more of a client and server of a storage system.

3. The shared computing system of claim 1, wherein the container pool is configured to provide a libservice as a standalone functionality derived from a library that runs an I/O function at the user level to provide an I/O service through composition with one or more other libservices.

4. The shared computing system of claim 1, wherein the application accesses the filesystem service through an interface supporting standard system calls.

5. The shared computing system of claim 1, wherein the container further comprises a plurality of applications, and wherein the container pool further comprises a plurality of filesystem services.

6. The shared computing system of claim 1, wherein the container pool is provided by a plurality of hosts, wherein a respective pool manager is provided for each host of the plurality of hosts to manage the container pool of each host to allocate resources for each host.

7. The shared computing system of claim 1, wherein the interprocess communication between the application and the filesystem service is configured to run at a kernel level to facilitate a dual interface implementation.

8. The shared computing system of claim 1, wherein the shared memory comprises a mount table configured to facilitate instantiating and accessing a filesystem instance of the filesystem service for a corresponding application.

9. The shared computing system of claim 8, wherein the mount table stores a mount path identifying an address of the filesystem service for access by the application.

10. The shared computing system of claim 9, wherein a filesystem table in the filesystem service specifies the filesystem instance that serves the mount path.

11. The shared computing system of claim 1, wherein the shared memory further comprises a queue to facilitate transferring requests from the application to the filesystem service.

12. The shared computing system of claim 11, wherein the container pool comprises one or more request buffers per application thread in the shared memory to transfer data and notifications between the application and the filesystem service.

13. The shared computing system of claim 11, wherein the queue comprises a fixed-size array data structure.

14. The shared computing system of claim 11, wherein the queue comprises two stages for each of enqueue and dequeue operations, wherein:
in a first stage an operation is assigned sequentially to one slot of a plurality of slots in the queue; and
in a second stage the operation is completed, wherein the second stage runs in parallel across the plurality of slots and without order restrictions relative to the one slot or other slots of the plurality of slots.

15. The shared computing system of claim 11, wherein the queue is configured to operate in a blocking mode.

16. The shared computing system of claim 11, wherein the queue is configured to operate in a non-blocking mode.

17. The shared computing system of claim 1, further comprising a two-stage pipeline for memory transfer to a destination memory address, wherein:
in a first stage a plurality of cache lines are prefetched into a non-temporal cache structure; and
in a second stage a plurality of prefetched cache lines are transferred to the destination memory address.

18. The shared computing system of claim 17, wherein a predetermined number of prefetches are performed prior to the plurality of prefetched cache lines being transferred to the destination memory address.

19. The shared computing system of claim 1, further comprising a memory copy with cross-platform optimization through offline exhaustive search to identify the best performance across different parameters including a data transfer size for a particular computing platform.

20. The shared computing system of claim 1, further comprising a memory copy with cross-platform optimization through search occurring during normal service to identify performance across different parameters.
